(19) United States
(12) Patent Application Publication
(10) Pub. No.: US 2026/0274180 A1
(43) Pub. Date: Sep. 17, 2026

(54) HARNESS HOLDER

(71) Applicant: HONDA MOTOR CO., LTD., Tokyo (JP)

(72) Inventors: Fumiaki TSUTSUI, Saitama (JP); Shota FUJIMURA, Saitama (JP); Shingo NAKATSU, Tochigi (JP)

(21) Appl. No.: 19/564,151

(22) Filed: Mar. 11, 2026

(30) Foreign Application Priority Data
Mar. 14, 2025 (JP) 2025-041299

(51) Int. Cl. B60R 16/02

(52) U.S. Cl. CPC B60R 16/0215

(57) ABSTRACT

A harness holder includes a holder body, a grommet, and a protector. The holder body is attached to a through-hole that penetrates through a housing. The holder body has an insertion hole for a harness to pass through. The grommet is attached to the insertion hole in a state in which the grommet has the harness inserted therethrough. The protector is attached to the holder body so as to protrude outside of the housing. The protector has a guide passage that guides the harness. The guide passage has a shape that extends in a penetration direction of the through-hole from a communication portion with the insertion hole to a predetermined direction-change portion, and then extends in a guide direction that is different from the penetration direction. The harness is bent along the guide passage at the direction-change portion, and thereby bending of the harness is maintained.

This application is based on and claims the benefit of priority from Japanese Patent Application No. 2025-041299, filed on 14 Mar. 2025, the content of which is incorporated herein by reference.

### BACKGROUND OF THE INVENTION

### Field of the Invention

The present invention relates to a harness holder that holds a harness.

### Related Art

Among harnesses that electrically connect an inside and an outside of a housing, there are some harnesses that are routed so as to pass through a through-hole penetrating through the housing.

Patent Document 1: PCT International Publication No. WO2016/013429

### SUMMARY OF THE INVENTION

The present inventors have paid attention to the fact that the following problems could occur in routing of such harnesses. For example, in a case where the housing is for a fuel cell stack or the like, and a liquid such as water or cleaning fluid is sprayed outside of the housing when washing a car or the like, there is a risk of the liquid entering the inside of the housing from the through-hole. Furthermore, when it is not possible to ensure much space outside the through-hole, there is a risk that routing of the harness may become difficult.

The present invention has been made in view of the above-described circumstances and has an object to make it possible to suppress a liquid from entering an inside of a housing from a through-hole even when the liquid is sprayed outside of the housing. Furthermore, the present invention has an object to make it possible to efficiently route a harness even when much space cannot be ensured outside of the through-hole.

The present inventors have found that the above-described objects can be achieved if a harness holder having a predetermined configuration is attached to a through-hole, and led to the present invention. The present invention is the harness holder of (1) to (8) as follows.

(1) A harness holder that holds a harness that electrically connects an inside and an outside of a housing, and includes

a holder body that is attached to a through-hole provided in the housing, and has an insertion hole for the harness to pass through,

a grommet that is attached to the insertion hole in a state in which the grommet has the harness inserted therethrough, and a protector that is attached to the holder body so as to protrude to outside of the housing, and has a guide passage that guides the harness. The guide passage has a shape that extends in a penetration direction of the through-hole from a communication portion with the insertion hole to a predetermined direction-change portion, and then extends in a guide direction different from the penetration direction, and bending of the harness is maintained by the harness being bent along the guide passage at the direction-change portion.

With the present configuration, the harness holder including the grommet is attached to the through-hole, and therefore even when a liquid is sprayed from outside of the housing, the liquid can be suppressed from entering the inside of the housing from the through-hole by the harness holder. Furthermore, the harness can be bent along the guide passage at the direction-change portion of the guide passage. Consequently, even when much space cannot be ensured outside the through-hole, it is possible to efficiently route the harness.

As above, with the present configuration, even when a liquid such as water is sprayed from outside of the housing, it is possible to suppress the liquid from entering the inside of the housing from the through-hole. Furthermore, even when much space cannot be ensured outside the through-hole, it is possible to efficiently route the harness.

(2) The harness holder according to the aforementioned (1) further includes a harness fixing portion that fixes a portion of the harness so that the harness is not drawn out in the guide direction, the portion being located ahead in the guide direction with respect to the direction-change portion.

With the present configuration, it is possible to more stably retain bending of the harness.

(3) In the harness holder according to the aforementioned (1) or (2),

the holder body includes a positioning portion on which an end portion in the penetration direction of the grommet abuts, the grommet has, on an outer circumferential surface thereof, a plurality of grommet-side fitting portions that are aligned in the penetration direction,

the insertion hole is provided with a plurality of body-side fitting portions that are fitted in the plurality of grommet-side fitting portions in a state in which the grommet abuts on the positioning portion,

one of each of the grommet-side fitting portions and each of the body-side fitting portions is a protruding portion, another of each of the grommet-side fitting portions and each of the body-side fitting portions is a recessed portion, and fitting the plurality of grommet-side fitting portions and the plurality of body-side fitting portions to each other forms a seal between the outer circumferential surface of the grommet and an inner circumferential surface of the insertion hole.

With the present configuration, it is possible to more firmly seal a space between the outer circumferential surface of the grommet, and the inner circumferential surface of the insertion hole.

(4) In the harness holder according to the aforementioned (1) or (2),

the holder body includes a positioning portion on which an end portion in the penetration direction of the grommet abuts, the grommet has, on an outer circumferential surface thereof, a plurality of protruding portions that are aligned in the penetration direction, and

pressing the plurality of protruding portions being pressed against an inner circumferential surface of the insertion hole forms a seal between the outer circumferential surface of the grommet, and the inner circumferential surface of the insertion hole.

With the present configuration, it is also possible to firmly seal the space between the outer circumferential surface of the grommet, and the inner circumferential surface of the insertion hole.

(5) In the harness holder according to any one of the aforementioned (1) to (4),

the grommet is attached to the insertion hole so that an end surface of the grommet on the protector side in the penetration direction is positioned on an opposite side with respect to the protector side in the penetration direction from an end surface of the housing on the protector side in the penetration direction.

With the present configuration, it is possible to start bending of the harness toward outside of the housing before the end surface on the protector side of the housing, and with this, it is possible to keep a radius R of curvature of the harness large. Accordingly, it is possible to reduce load of the harness at a bending portion, and it is possible to smoothly bend the harness.

(6) In the harness holder according to any one of the aforementioned (1) to (5), a fastening portion for fastening the holder body to the housing is provided in a portion of the holder body, the portion being positioned in a direction orthogonal to the guide direction from the insertion hole in the holder body, as seen in the penetration direction.

With the present configuration, it is possible to dispose the fastening portion while avoiding interference with the guide passage.

(7) In the harness holder according to the aforementioned (6),

the protector has at least one fitting hole that is provided in at least one of a portion of the protector positioned on an opposite side to the fastening portion side in the direction orthogonal to the guide direction from the insertion hole, or a portion of the protector positioned on an opposite side to the guide direction from the insertion hole, as seen in the penetration direction,

the holder body has a fitting claw that fits in the fitting hole, and

fitting the fitting hole and the fitting claw to each other causes the protector to be fixed to the holder body.

With the present configuration, it is possible to assemble the protector to the holder body without any mistake in orientation, based on the positions of the fitting hole and the fitting claw.

(8) In the harness holder according to any one of the aforementioned (1) to (7),

the harness holder has, in a portion thereof located on the protector side with respect to the grommet, a discharge portion that is capable of discharging a liquid that has entered an inside of the guide passage to outside of the harness holder and outside of the housing.

With the present configuration, even when a liquid enters the inside of the guide passage, the liquid can be discharged to outside of the harness holder and outside of the housing from the discharge portion.

As above, with the configuration of the aforementioned (1), even when a liquid such as water is sprayed outside the housing, the liquid can be suppressed from entering the inside of the housing from the through-hole. Furthermore, even when much space cannot be ensured outside the through-hole, it is possible to efficiently route the harness. Furthermore, with the configurations of the aforementioned (2) to (8) citing the aforementioned (1), additional effects thereof are obtained.

### BRIEF DESCRIPTION OF THE DRAWINGS

FIG. 1 is a perspective view showing a harness holder and surroundings thereof according to a first embodiment;

FIG. 2 is an exploded perspective view showing the harness holder and the surroundings thereof;

FIG. 3 is a view of the harness holder seen in an X direction;

FIG. 4 is a view showing a section along line fg4-fg4 in FIG. 3;

FIG. 5 is a perspective view showing a state in which a harness fixing portion is opened;

FIG. 6 is a perspective view showing a state in which the harness fixing portion is closed; and

FIG. 7 is a view of a harness holder of a modified mode seen in the X direction.

### DETAILED DESCRIPTION OF THE INVENTION

Hereinafter, an embodiment of the present invention will be described with reference to the drawings. However, the present invention is not limited to the following embodiment in any way and can be carried out by being appropriately modified within the scope without departing from the gist of the present invention.

### First Embodiment

Hereinafter, predetermined three directions that are orthogonal to one another will be referred to as an "X direction", a "Y direction", and a "Z direction". Furthermore, one side in the X direction is referred to as an "X1 side", and an opposite side thereto is referred to as an "X2 side". Furthermore, one side in the Y direction is referred to as a "Y1 side", and an opposite side thereto is referred to as a "Y2 side". Furthermore, one side in the Z direction is referred to as a "Z1 side", and an opposite side thereto is referred to as a "Z2 side". Note that in the present embodiment, the Z direction is vertical, and the X direction and the Y direction are horizontal.

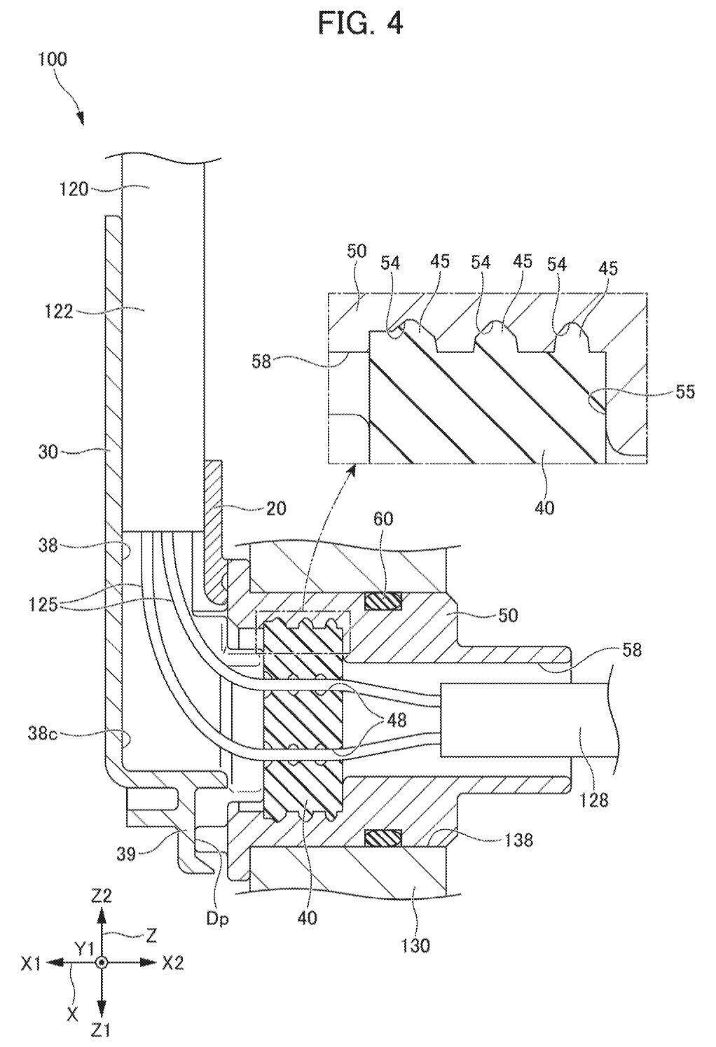

As shown in FIG. 4, a housing 130 includes a through-hole 138 for a harness 120 to be inserted through. The harness 120 electrically connects an inside and an outside of the housing 130. The through-hole 138 penetrates through the housing 130 in the X direction. Accordingly, the "X direction" may be interpreted as a "penetration direction".

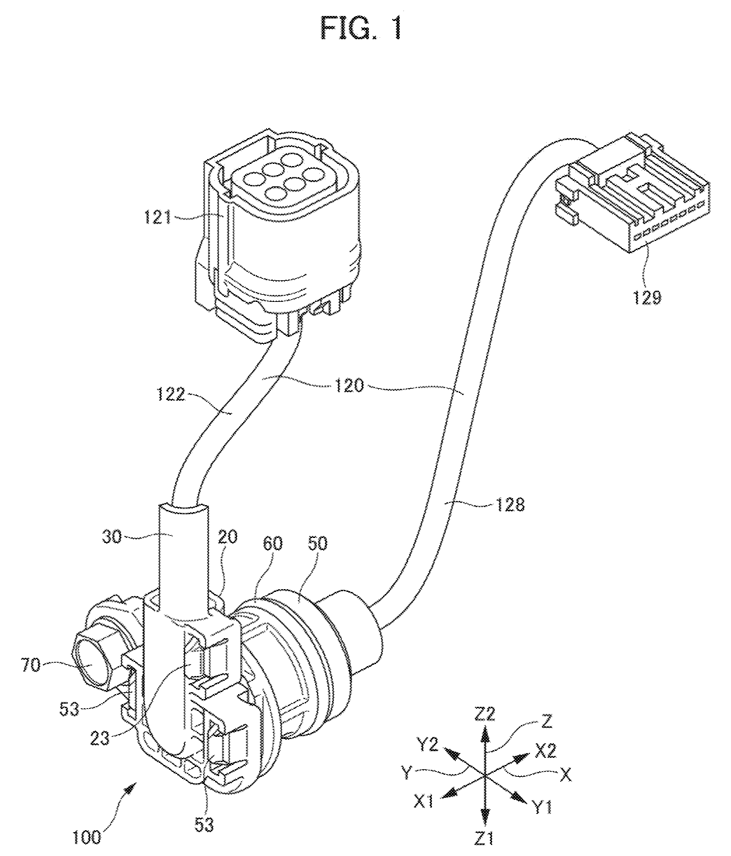

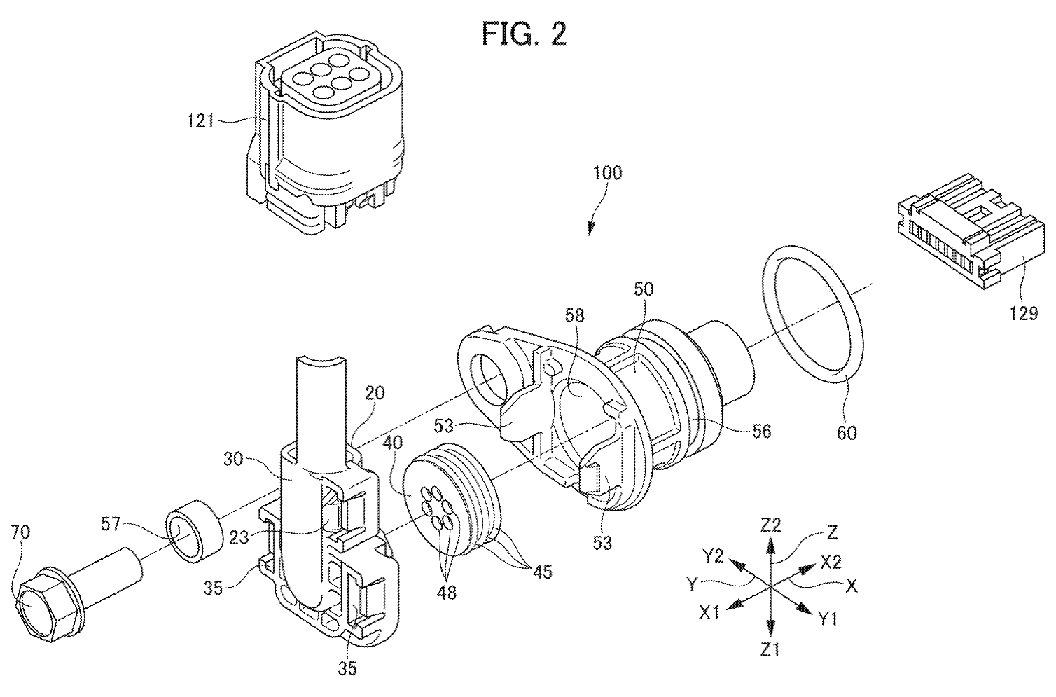

As shown in FIG. 1, a harness holder 100 holds an intermediate portion of the harness 120. Note that the "intermediate portion of the harness 120" mentioned here is a portion except for connectors 121 and 129 that are attached to both ends thereof, in the harness 120. As shown in FIG. 2, the harness holder 100 includes a holder body 50, a grommet 40, and a protector 30.

As shown in FIG. 4, the holder body 50 is attached to the through-hole 138. The holder body 50 has an insertion hole 58 for the harness 120 to pass through. The grommet 40 is attached to the insertion hole 58 so as not to protrude to the X1 side from the through-hole 138 in a state in which the grommet 40 has the harness 120 inserted therethrough.

The protector 30 is attached to the holder body 50 so as to protrude to outside of the housing 130, that is, protrude to the X1 side. The protector 30 includes a guide passage 38 that guides the harness 120. The guide passage 38 has a shape that extends to the X1 side to a predetermined direction-change portion 38c from a communication portion with the insertion hole 58, and thereafter extends to the Z2 side. Accordingly, the "Z2 side" may be interpreted as a "guide direction". Since the harness 120 is bent along the guide passage 38 at the direction-change portion 38c in this manner, bending of the harness 120 is maintained.

The holder body 50 includes a positioning portion 55 that abuts on an end portion at the X2 side in the grommet 40. The grommet 40 has, on an outer circumferential surface thereof, a plurality of protruding portions 45 that are aligned in the X direction. On an inner circumferential surface of the insertion hole 58, a plurality of recessed portions 54 that engage with the plurality of protruding portions 45 of the grommet 40 are provided in a state in which the grommet 40 abuts on the positioning portion 55. Fitting the plurality of protruding portions 45 and the plurality of recessed portions 54 to each other forms a seal between an outer circumferential surface of the grommet 40 and the inner circumferential surface of the insertion hole 58. Note that the "protruding portion 45" may be interpreted as a "grommet-side fitting portion", and the "recessed portion 54" may be interpreted as a "body-side fitting portion".

However, instead of this, the recessed portions 54 may be eliminated from the inner circumferential surface of the insertion hole 58. In this case, the seal is formed by the plurality of protruding portions of the grommet 40 receiving pressure from the inner circumferential surface of the insertion hole 58.

Furthermore, the plurality of protruding portions 45 of the grommet 40, and the recessed portions 54 on the inner circumferential surface of the insertion hole 58 may be reversed. That is to say, a plurality of recessed portions may be formed on the grommet 40, whereas protruding portions are formed on the inner circumferential surface of the insertion hole 58, and the seal may be formed by these recessed portions and protruding portions being fitted to each other. Note that in this case, the "recessed portion" can be interpreted as a "grommet-side fitting portion", and the "protruding portion" can be interpreted as a "body-side fitting portion".

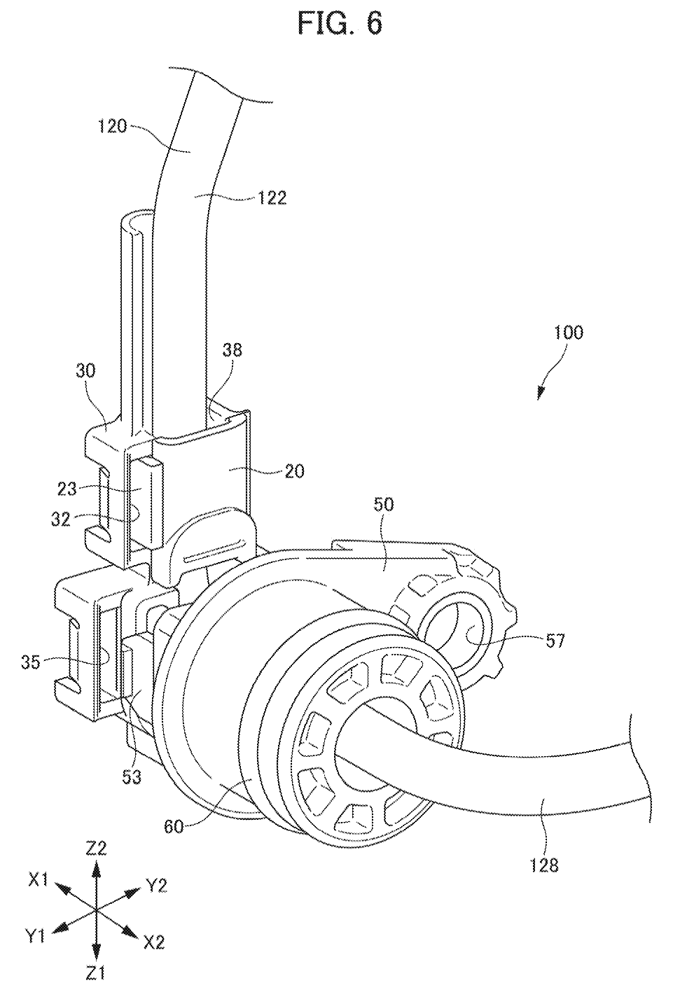

As shown in FIG. 6, a harness fixing portion 20 that fixes the harness 120 so that it is not drawn out in the Z direction is attached to the protector 30.

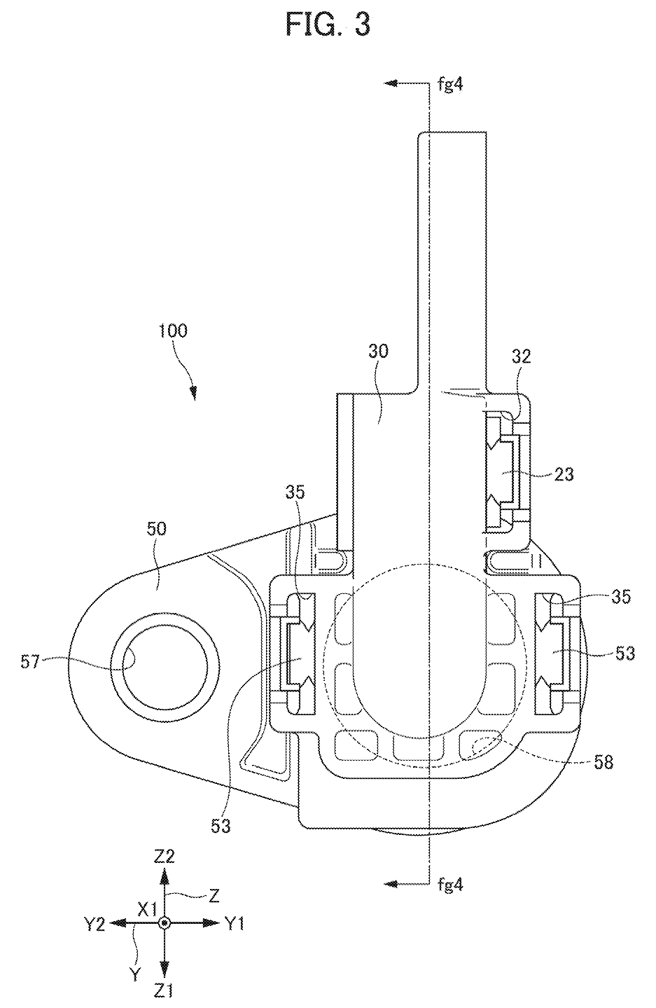

As shown in FIG. 3, as seen from the X1 side, a fastening portion 57 that is a hole for fastening the holder body 50 to the housing 130 with a bolt 70 is provided in a portion of the holder body 50 that is positioned at the Y2 side from the insertion hole 58.

Furthermore, as seen from the X1 side like this, fitting holes 35 are provided respectively at the Y1 side and the Y2 side from the insertion hole 58 in the protector 30. The holder body 50 includes fitting claws 53 that fit into the fitting holes 35. The protector 30 is fixed to the holder body 50 by fitting of these fitting holes 35 and the fitting claws 53.

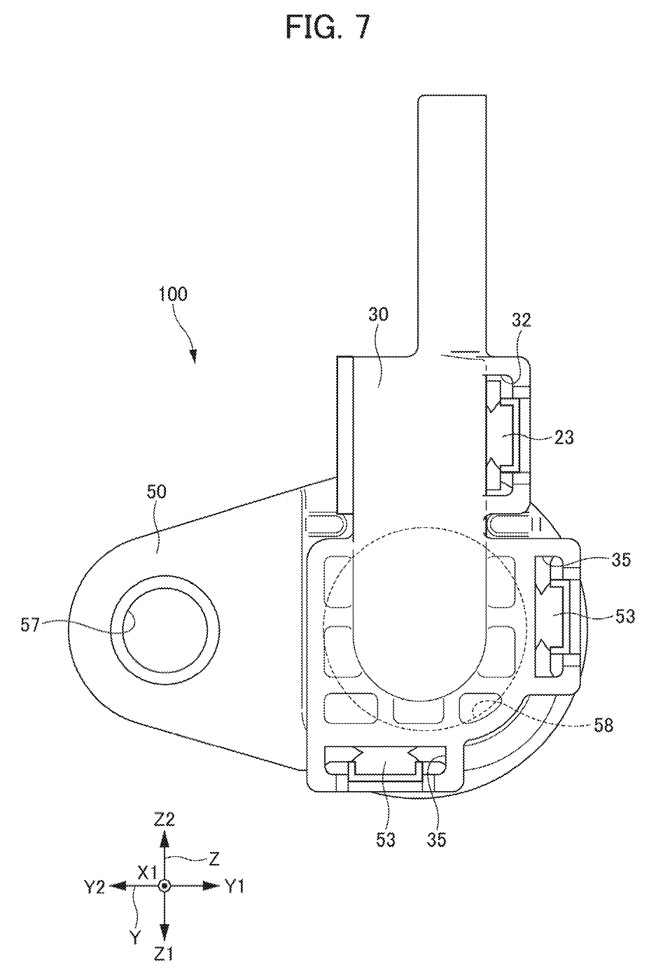

However, in addition to these two fitting holes 35, or instead of one of the fitting holes 35, the fitting hole 35 may be provided at the Z1 side or the Z2 side from the insertion hole 58 in the protector 30, as shown in FIG. 7. In this case, at least one fitting hole 35 and one fitting claw 53 are provided on each of the Y direction side and the Z direction side from the insertion hole 58, and thereby the protector 30 can be assembled to the holder body 50 without any mistake in orientation.

As shown in FIG. 4, at a portion at the X1 side from the grommet 40 in the harness holder 100, a discharge portion Dp that is capable of discharging a liquid that has entered an inside of the guide passage 38 to outside of the harness holder 100 and outside of the housing 130 is provided.

Hereinafter, the present embodiment will be described in more detail.

As shown in FIG. 1, the connectors 121 and 129 are attached to both ends of the harness 120. Note that as described above, the "intermediate portion of the harness 120" is the portion except for these connectors 121 and 129, in the harness 120.

The protector 30 and the holder body 50 shown in FIG. 2 are made of resin. On the other hand, the grommet 40 is made of rubber. The insertion hole 58 penetrates through the holder body 50 in the X direction. The grommet 40 has a plurality of grommet holes 48 that penetrate therethrough in the X direction. The plurality of protruding portions 45 that are on the outer circumferential surface of the grommet 40 are provided annularly along the outer circumferential surface. From the above, the plurality of recessed portions 54 that are on the inner circumferential surface of the holder body 50 are also provided annularly along the inner circumferential surface. An O-ring groove 56 is annularly provided on an outer circumferential surface of the holder body 50. An O-ring 60 is attached to the O-ring groove 56.

As shown in FIG. 3, a peripheral portion of the fastening portion 57 in the holder body 50 is provided separately from other portions in the holder body 50. Note that in the present embodiment, as seen from the X1 side as shown in FIG. 3, the fastening portion 57 is provided at the Y2 side from the insertion hole 58, but the fastening portion 57 may be provided at the Y1 side, the Z1 side, or the Z2 side from the insertion hole 58 as long as it is separated from the other portions in the holder body 50.

The housing 130 shown in FIG. 4 contains a fuel cell stack, in the present embodiment. However, it may be a housing that contains other items than this. The protector 30 covers the grommet 40 from the X1 side by abutting on the grommet 40 from the X1 side. The discharge portion Dp is a gap provided between the protector 30 and the holder body 50. A protrusion 39 that protrudes to the Z1 side to prevent a liquid from entering an inside of the harness holder 100 inversely from the discharge portion Dp is provided at a portion that is positioned at the X1 side from the discharge portion Dp in the protector 30.

The harness 120 includes a plurality of conducting wires 125, and a first cover 122 and a second cover 128 that cover the plurality of conducting wires 125. Specifically, the first cover 122 covers portions that are placed outside of the housing 130 in the plurality of conducting wires 125. On the other hand, the second cover 128 covers portions that are placed an inside of the housing 130 in the plurality of conducting wires 125. A waterproof tape or the like is wrapped around a portion including a space between the first cover 122 and the protector 30. Inside of the harness holder 100, the respective conducting wires 125 are inserted through the grommet holes 48. Note that FIG. 4 shows only two conducting wires 125, but the number of the conducting wires 125 is the same number as the number of the grommet holes 48 shown in FIG. 2.

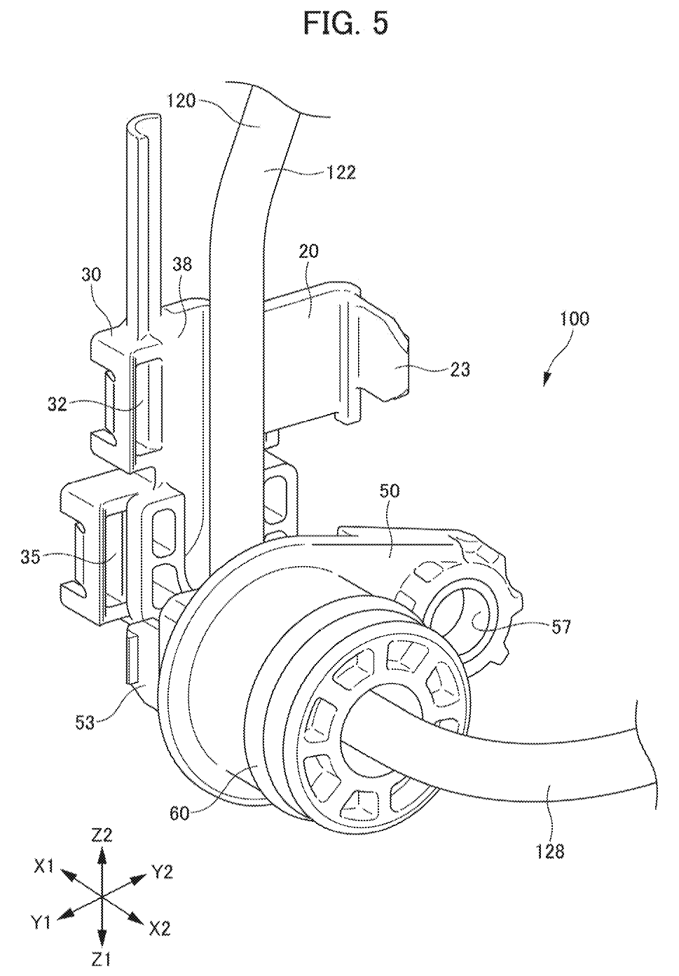

As shown in FIG. 5, the harness fixing portion 20 is attached to the protector 30 so as to be rotatable about an axis in the Z direction. For this reason, the harness fixing portion 20 is configured to be openable and closable about the axis in the Z direction. The harness fixing portion 20 includes an engaging claw 23. On the other hand, the protector 30 includes an engaging hole 32 that is fitted on the engaging claw 23.

In a state in which the harness fixing portion 20 is opened as shown in FIG. 5, the guide passage 38 opens in a groove shape. On the other hand, in a state in which the harness fixing portion 20 is closed as shown in FIG. 6, the guide passage 38 is in a hole shape.

Hereinafter, a configuration and effects of the present embodiment will be summarized.

As shown in FIG. 4, the harness holder 100 including the grommet 40 is attached to the through-hole 138. In addition, the O-ring 60 is present between the outer circumferential surface of the holder body 50 and the inner circumferential surface of the through-hole 138. Consequently, even when a liquid is sprayed outside of the housing 130, it is possible to suppress the liquid from entering the inside of the housing 130 from the through-hole 138 by the harness holder 100. In addition, the harness 120 is bent along the guide passage 38 at the direction-change portion 38c of the guide passage 38. Consequently, even when much space cannot be ensured outside of the through-hole 138, that is, at the X1 side, it is also possible to efficiently route the harness 120.

As shown in FIG. 4, the harness fixing portion 20 that fixes the portion at the Z2 side from the direction-change portion 38c in the harness 120 so that it is not drawn out to the Z2 side is attached to the protector 30. For this reason, it is possible to more stably retain bending of the harness 120.

As shown in FIG. 5, the harness fixing portion 20 is provided to be openable and closable about the axis in the Z direction. Consequently, even when the connectors 121 and 129 are already attached fixedly to the end portions of the harness 120, it is possible to easily install the intermediate portion of the harness 120 in the guide passage 38.

Since the protector 30 shown in FIG. 1 is made of resin, it is possible to suppress sway of the harness 120 and suppress contact of the harness 120 with the peripheral members thereof as compared with the case where it is made of rubber.

As shown in FIG. 4, the holder body 50 includes the positioning portion 55 on which the end portion at the X2 side of the grommet 40 abuts is provided at the holder body 50. On the outer circumferential surface of the grommet 40, the plurality of protruding portions 45 are formed to be aligned in the X direction. The plurality of recessed portions 54 that fit onto the plurality of protruding portions 45 of the grommet 40 in a state in which the grommet 40 abuts on the positioning portion 55, are provided on the inner circumferential surface of the insertion hole 58. Fitting of the plurality of the protruding portions 45 to the plurality of the recessed portions 54 makes it possible to more firmly seal the space between the outer circumferential surface of the grommet 40, and the inner circumferential surface of the insertion hole 58.

As shown in FIG. 4, an end surface at the X1 side of the grommet 40 is attached to the insertion hole 58 so as to be positioned at the X2 side from an end surface at the X1 side of the housing 130. For this reason, a bending start position of the harness 120 is further located at a back side, that is, at the X2 side, and the harness 120 can be bent more smoothly in the direction-change portion 38c.

As seen from the X1 side as shown in FIG. 3, the fastening portion 57 for fastening the holder body 50 to the housing 130 is provided at the portion that is positioned at the Y2 side from the insertion hole 58 in the holder body 50. For this reason, it is possible to dispose the fastening portion 57 while avoiding interference with the guide passage 38 that extends to the Z2 side from the insertion hole 58.

As seen from the X1 side as shown in FIG. 3, the fitting holes 35 are respectively provided at the portions positioned at the Y1 side and the Y2 side from the insertion hole 58 in the protector 30. The holder body 50 includes the fitting claws 53 that are fitted to these fitting holes 35. From the above, it is possible to dispose the fitting holes 35 and the fitting claws 53 while avoiding interference with the guide passage 38 that extends to the Z2 direction from the insertion hole 58.

As shown in FIG. 4, the discharge portion Dp that is capable of discharging the liquid that has entered the inside of the guide passage 38 to outside of the harness holder 100 and outside of the housing 130 is provided at the portion at the X1 side from the grommet 40 in the harness holder 100. For this reason, even when a liquid enters the inside of the guide passage 38, it is also possible to discharge the liquid to outside of the harness holder 100 and outside of the housing 130 from the discharge portion Dp.

### Other Embodiments

The embodiment shown above can be changed as follows, for example.

The Z direction shown in FIG. 1 may be a direction diagonal to a vertical direction, and one or both of the X direction and the Y direction may be a direction or directions diagonal to a horizontal direction. Furthermore, one of the X direction and the Y direction may be vertical, and the other one of the X direction and the Y direction, and the Z direction may be horizontal.

In place of the discharge portion Dp shown in FIG. 4, a discharge portion formed of a discharge hole that is provided to penetrate through the protector 30 may be provided. The harness fixing portion 20 shown in FIG. 6 may be detachably attached to the protector 30.

### EXPLANATION OF REFERENCE NUMERALS

20 harness fixing portion

30 protector

35 fitting hole

38 guide passage

38c direction-change portion

40 grommet

45 protruding portion (grommet-side fitting portion)

50 holder body

53 fitting claw

54 recessed portion (body-side fitting portion)

55 positioning portion

57 fastening portion

58 insertion hole

100 harness holder

120 harness

130 housing

138 through-hole

Dp discharge portion

X penetration direction

Z2 guide direction

What is claimed is:

1. A harness holder that holds a harness that electrically connects an inside and an outside of a housing, the harness holder comprising:
a holder body that is attached to a through-hole provided in the housing, and has an insertion hole for the harness to pass through;
a grommet that is attached to the insertion hole in a state in which the grommet has the harness inserted therethrough; and
a protector that is attached to the holder body so as to protrude to outside of the housing, and has a guide passage that guides the harness, wherein
the guide passage has a shape that extends in a penetration direction of the through-hole from a communication portion with the insertion hole to a predetermined direction-change portion, and then extends in a guide direction different from the penetration direction, and
bending of the harness is maintained by the harness being bent along the guide passage at the direction-change portion.

2. The harness holder according to claim 1, further comprising:
a harness fixing portion that fixes a portion of the harness so that the harness is not drawn out in the guide direction, the portion being located ahead in the guide direction with respect to the direction-change portion.

3. The harness holder according to claim 1, wherein
the holder body includes a positioning portion on which an end portion in the penetration direction of the grommet abuts,
the grommet has, on an outer circumferential surface thereof, a plurality of grommet-side fitting portions that are aligned in the penetration direction,
the insertion hole is provided with a plurality of body-side fitting portions that are fitted in the plurality of grommet-side fitting portions in a state in which the grommet abuts on the positioning portion,
one of each of the grommet-side fitting portions and each of the body-side fitting portions is a protruding portion,
another of each of the grommet-side fitting portions and each of the body-side fitting portions is a recessed portion, and
fitting the plurality of grommet-side fitting portions and the plurality of body-side fitting portions to each other forms a seal between the outer circumferential surface of the grommet and an inner circumferential surface of the insertion hole.

4. The harness holder according to claim 1, wherein
the holder body includes a positioning portion on which an end portion in the penetration direction of the grommet abuts,
the grommet has, on an outer circumferential surface thereof, a plurality of protruding portions that are aligned in the penetration direction, and
pressing the plurality of protruding portions against an inner circumferential surface of the insertion hole forms a seal between the outer circumferential surface of the grommet and the inner circumferential surface of the insertion hole.

5. The harness holder according to claim 1, wherein
the grommet is attached to the insertion hole so that an end surface of the grommet on the protector side in the penetration direction is positioned on an opposite side with respect to the protector side in the penetration direction from an end surface of the housing on the protector side in the penetration direction.

6. The harness holder according to claim 1, wherein
a fastening portion for fastening the holder body to the housing is provided in a portion of the holder body, the portion being positioned in a direction orthogonal to the guide direction from the insertion hole in the holder body, as seen in the penetration direction.

7. The harness holder according to claim 6, wherein
the protector has at least one fitting hole that is provided in at least one of a portion of the protector positioned on an opposite side to the fastening portion side in the direction orthogonal to the guide direction from the insertion hole, or a portion of the protector positioned on an opposite side to the guide direction from the insertion hole, as seen in the penetration direction,
the holder body has a fitting claw that fits in the fitting hole, and
fitting the fitting hole and the fitting claw to each other causes the protector to be fixed to the holder body.

8. The harness holder according to claim 1, wherein
the harness holder has, in a portion thereof located on the protector side with respect to the grommet, a discharge portion that is capable of discharging a liquid that has entered an inside of the guide passage to be discharged to outside of the harness holder and outside of the housing.
